(19) United States
(12) Patent Application Publication
(10) Pub. No.: US 2007/0246400 A1
(43) Pub. Date: Oct. 25, 2007

(54) Zeolite Catalysts

(76) Inventors: Klaus Jens, Stathelle (NO); Trond Myrstad, Vikhammer (NO); Ivar Dahl, Trondheim (NO); Ase Slagtern, Trondheim (NO)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/571,309

(22) PCT Filed: Jan. 5, 2006
(86) PCT No.: PCT/EP05/06927

§ 371 Date: May 5, 2007

(30) Foreign Application Priority Data
Jun. 28, 2004 (GB) 0414442.4

(51) Int. Cl. B01J 29/40

(52) U.S. Cl. 208/111.01; 208/120.01

(57) ABSTRACT

A process for cracking C₄+ hydrocarbons comprising heating the hydrocarbons at a temperature of 400-800° C. in the presence of an H-ZSM-5 catalyst having a silicon to aluminium ratio of 61-1000.

This invention relates to the cracking of higher hydrocarbons into alkenes using the hydrogen form of pentasil type zeolite catalysts (HZSM-5). In particular, the invention relates to the use of HZSM-5 catalysts having specific silicon to aluminium ratios in the cracking of hydrocarbons to give high yields of propylene.

Zeolites are a well-known class of aluminosilicates containing an (Si, Al)ₙO₂ₙ framework with negative charge balanced by cations present in the framework cavities. The nature of the cations used can vary greatly but typical examples include potassium, sodium, calcium, silver and hydrogen. The spaces created within a zeolite framework are relatively large and these so called “cages” can accommodate large molecules. However, the external pores of the framework which allow access to the cages of the zeolite tend to be smaller, allowing control over the sizes of molecules which can enter and leave the zeolite structure.

The possibility of size selectivity has made use of zeolite catalysts an attractive option for the skilled chemist when carrying out cracking reactions, i.e. reactions where higher hydrocarbons are broken down into smaller hydrocarbon fragments, as well as other reactions such as isomerisation reactions or aromatisation reactions.

The cracking of higher hydrocarbons into smaller hydrocarbons, in particular ethylene and propylene, is well known and has been carried out in the petrochemical industry for many years. For example, the use of a steam cracker to convert higher hydrocarbons by pyrolysis into ethylene and propylene is well known. In general however this reaction produces much more ethylene than propylene. Zeolite catalysis therefore provides a further cracking alternative for the skilled chemist.

U.S. Pat. No. 6,222,087 describes the use of phosphorus doped ZSM-5 and/or ZSM-1 zeolites in the formation of light olefins rich in propylene from a hydrocarbon feed containing C₄₋₇ olefins/paraffins. With a 1-butene feed the invention realises 37% ethylene and propylene but with a light catalytic naphtha feed only 25% ethylene and propylene is formed.

U.S. Pat. No. 5,968,342 describes the use of various metal doped zeolites as catalysts in the conversion of naphtha to ethylene and propylene. ZSM-5 catalysts in which the proton is exchanged with silver or copper are suggested to ensure that the zeolite is substantially free of protons. The text suggests that HZSM catalysts show poor selectivity for lower olefins. GB 2345294 describes a process similar to that in U.S. Pat. No. 5,968,342, i.e. one in which a proton free zeolite is employed in a cracking reaction.

WO 00/18853 describes ZSM-5 catalysts doped with phosphorus and a further promoter such as tin or gallium for use in cracking naphtha to olefins.

With the increasing demand for propylene throughout the world, in particular the increasing demand for polypropylene, it would be useful if more of the heavier petrochemical fractions could be converted efficiently into propylene for polymerisation.

Such heavier petrochemical fractions are often rich in aromatic compounds notably benzene. The use of aromatic compounds in fuels is being reduced for environmental reasons resulting in a potential surplus of aromatic compounds. Moreover, whilst there is a market for benzene, the market is relatively small. Thus, it is anticipated that the market for aromatic compounds may become saturated. It would therefore be useful if aromatic compounds such as benzene could themselves be converted in high yield into more marketable olefins such as ethylene and propylene.

There remains therefore, the need for further cracking processes to be developed to maximise the yields of ethylene and propylene which can be obtained from hydrocarbon feeds. In particular it would be useful if the amounts of propylene produced could be maximised. It has now been surprisingly found that by using a hydrogen ZSM-5 catalyst with a particular silicon to aluminium molar ratio hydrocarbons, such as hydrogenated aromatic fractions or hydrocarbon fractions containing higher olefins, can be cracked into ethylene and propylene in very high yields. Contrary to the teachings of the prior art, these catalysts show excellent olefin selectivity at the Si/Al molar ratios claimed and can be used to crack a variety of feeds to give rise to olefins such as ethylene and propylene in high yield.

Thus, viewed from one aspect the invention provides a process for cracking C₄+ hydrocarbons comprising heating the hydrocarbons at a temperature of 400-800° C. in the presence of an H-ZSM-5 catalyst having a silicon to aluminium ratio of 61-1000.

Viewed from another aspect the invention provides the use of an HZSM-5 catalyst having a silicon to aluminium ratio of 61-1000 as a catalyst in the cracking of C₄+ hydrocarbons.

The process of the invention may be used on its own or in combination with other processes such as alternative olefin producing processes, e.g. pyrolytic steam cracking.

By C₄+ hydrocarbons is meant that the hydrocarbons being cracked have at least four carbon atoms. Preferably, the hydrocarbons being cracked will have between 4 and 20 carbon atoms, preferably between 5 and 12 carbon atoms, e.g. 6 to 10 carbon atoms. The hydrocarbon feedstock can be a single pure hydrocarbon but more usually it will be a mixture of various hydrocarbons, e.g. a light or heavy naphtha fraction, different condensate fractions or a hydrogenated pyrolysis gasoline. The hydrocarbons may be saturated or unsaturated, linear, branched or cyclic and preferably non-aromatic. Preferred hydrocarbons however will be saturated paraffins (alkanes such as pentane, hexane, octane, decane, dodecane), olefins of general formula CₙH₂ₙ where n is from 4 to 12 or most preferably saturated cyclic hydrocarbons, e.g. cyclopentane, cyclohexane, methylcyclohexane, dimethylcyclohexane, methylcyclopentane or decalin. The hydrocarbon feedstock may also be a mixture of any of the above. In a highly preferred embodiment the feedstock comprises at least one C4+ olefin, e.g. a C5+ olefin or diene.

The hydrocarbon feed may contain aromatic compounds such as benzene. Such aromatics do not, in general, crack in the presence of the HZSM-5 catalyst of the invention and are therefore left unchanged. Aromatic compounds may therefore be used as diluents in the process of the invention. Preferably however, it would be useful to convert aromatic compounds into useful olefins.

Many of the potential feeds to the catalytic cracker contain high volumes of aromatic compounds, e.g. pyrolysis gasoline or condensate fractions direct from an oil refinery or an oil producer.

In a preferred embodiment therefore, the hydrocarbon feed may be hydrogenated prior to exposure to the zeolite catalyst. Thus for example, a hydrocarbon feedstock containing benzene can be hydrogenated to give cyclohexane prior to cracking. By hydrogenating the feedstock, the majority of the hydrocarbons fed to the cracking reactor will be saturated, i.e. alkanes and cyclic saturated hydrocarbons. This forms a further aspect of the invention.

Thus viewed from a further aspect the invention provides a process comprising hydrogenating a C₄+ hydrocarbon feedstock; and heating the resulting hydrocarbons at a temperature of 400-800° C. in the presence of an H-ZSM-5 catalyst having a silicon to aluminium ratio of 61-1000.

A potential reactor set up could involve diluent free cracking, e.g. using a hydrogenated pyrolysis gas feed with recycling of C4+ fractions to the hydrogenator. Alternatively, a reactor set up could involve the use of an aromatic compound as a diluent for a hydrocarbon feedstock. Pyrolysis gasoline from a naphtha steam cracker, which contains a large amount of aromatic compounds, would, for example, be suitable as such a diluent.

The cracker may then have a recycling system which passes through a hydrogenator to convert the diluent into a crackable hydrocarbon. This may then be fed back into the cracker (along with fresh diluent) so that in a first pass, the aromatic compound acts as a diluent prior to hydrogenation and itself being cracked. Recycling of C4+ fractions could occur simultaneously.

Preferably the temperature within the cracking reactor should range from 500-750° C., more preferably 550-700° C., especially 550 to 650° C., e.g. 570° to 650° C. or 570 to 630° C. such as about 600° C. The residence time of the feed over the catalyst should be long enough to give substantial conversion of the feed but not long enough to give rise to the production of large percentages of aromatic compounds.

It has been surprisingly found that when the process described above is employed the yield (calculated as weight of carbon) of ethylene and propylene can exceed 40 wt % carbon. Thus, 40% by weight of the carbon in the hydrocarbon feedstock is recovered as ethylene and propylene. Preferably at least 50 wt % carbon is recovered as ethylene and propylene.

Whilst the ratio of produced propylene to ethylene can vary, e.g. more ethylene than propylene or a 1:1 ratio, preferably, the bulk of the produced product is propylene e.g. at least 25 wt % C, especially 30 wt % C. It is also preferred if the ratio of produced propylene to ethylene is greater than 1.2:1, e.g. greater than 1.5:1.

An important factor in ensuring high percentage yields of ethylene and propylene is ensuring high conversion of initial feedstock. It is preferred if at least 50% of the initial feedstock is cracked, especially at least 60%, e.g. 70%, most especially at least 80% or at least 90%. At higher temperatures, conversion can near 100%. The higher the cracking temperature the higher the conversion. Also at higher temperatures, ethylene selectivity increases. There is, however, a trade off between temperature and hence high conversion/desired selectivity and potential for formation of aromatic compounds. The most preferred temperature to maximize conversion but minimise benzene formation is in the range 570 to 630° C.

Viewed from another aspect the invention provides a process for cracking C₄+ hydrocarbons comprising heating the hydrocarbons at a temperature of 400-800° C. in the presence of an H-ZSM-5 catalyst having a silicon to aluminium ratio of 61-1000 and recovering the cracked hydrocarbons;

wherein at least 40% wt carbon of the cracked C₄+ hydrocarbons is recovered as ethylene and propylene.

Any non-converted feedstock can of course be recycled back into the cracker along with any unwanted side products. The cracking reaction obviously yields hydrocarbons other than ethylene and propylene. Other products may include ethane, propane, methane, butane, butene and amounts of C5 and C6+ fractions.

Catalytic cracking reactors of use in the invention are known and can operate under the temperatures discussed above using pressure if necessary, e.g. from 0.1 to 10 atm, preferably 0.3 to 2 atm. The catalytic process can be carried out in, for example, a fixed bed, moving bed, or fluidised bed reactor and the hydrocarbon flow can be cocurrent or countercurrent to catalyst flow.

The catalyst may be formed from fine solid particles having a size range of from about 0.01 to 10 mm, e.g. 0.2 to 5 mm. Diluent such as an inert gas (nitrogen), methane or aromatic compounds can be employed as is known in the art, e.g. to carry the hydrocarbon gas stream into the reactor. The ratio of inert gas (if used) to hydrocarbons may range from 0:1 to 1000:1. Careful selection of diluents may allow further control over the ratio of products formed. Comprehensive discussions of suitable reactor set up can be found in the prior art cited above and are known in the art.

The catalyst employed in the invention, i.e. a HZSM-5 catalyst having a particular Si/Al molar ratio is obtainable from commercial sources such as Sud-Chemie. Silicon to aluminium ratios given in the text are molar ratios, i.e. by a Si/Al ratio of 100 is meant that the molar amount of Si is 100 times the molar amount of Al. The manufacture of ZSM-5 catalysts is described in U.S. Pat. No. 3,702,886. Preferred silicon to aluminium ratios are 80-400, especially 100-300, e.g. 85 to 200. It has been surprisingly found that at these high ratios, the amounts of formed lower olefins are high, in contrast to products obtained when using HZSM-5 catalysts having lower Si/Al ratios. The catalyst is preferably medium pore (e.g. 10 rings).

Comprehensive discussions of the manufacture and use of ZSM-5 catalysts can be found in the prior art cited above. The amount of catalyst employed will vary depending on the size of the reactor and the size of the feed but will be readily determined by the artisan. Catalyst can be continuously added to the cracker if necessary. It may also be necessary to regenerate the catalyst using known conditions. It has however, been surprisingly found that the catalyst of the invention only exhibits slow loss of activity during the cracking reaction and hence regeneration may be required only infrequently.

It is common for the zeolites to be calcined prior to use, however it is preferred if the HZSM-5 catalyst used in the present invention is not calcined. Moreover, many zeolite catalysts are aged prior to use by exposing them to hydrothermal treatment, e.g. heating at a temperature of 500 to 800° C. in the presence of steam. The zeolites used in the present invention should not be heated in this fashion prior to use since this may affect their light olefin selectivity, i.e. it is not necessary to expose the zeolite catalysts of the invention to elevated temperatures and 100% steam before use.

The catalyst of use in the invention is an HZSM-5 species as hereinbefore described. Hence, the cations within the zeolite should be protons. There is the possibility however that the zeolite may be contaminated with other cations, e.g. sodium or potassium ions. It is preferred if the zeolite of use in this invention comprises primarily protons with low amounts of other cations, e.g. exclusively protons and no other cations. For example, the level of cations (other than protons) should be less than 0.05% wt, preferably less than 0.01% wt.

It may be necessary to control the contact time of the hydrocarbon materials with the catalyst by taking pyrolysis properties of the hydrocarbons and reaction temperature into consideration. Contact times, measured as 1/GHSV (gas hourly space velocity) should be from 0.00002 h to 0.002 h.

The products of the cracking reaction can be fractionated using known techniques. Any unwanted products may be recycled to the reactor so as to increase yield of the desired product(s). Larger side products may be channeled into a condenser prior to recycling.

A suitable reactor set up is now described. The setup used in the first Example is shown schematically in FIG. 1 and represents an alternative for carrying out a small scale cracking reaction. The skilled chemist/chemical engineer can take the principles described herein for use in an industrial cracking reactor. Fluid hydrocarbons enter the apparatus via liquid pump (1) and enter evaporator (3). An inert gas, e.g. nitrogen, is fed to the evaporator via mass flow controller (2). Gaseous hydrocarbons formed in the evaporator enter reactor (6) containing catalyst (10) in oven (5) via flow switch (4). After cracking, the material from the reactor is transferred to condenser (7) where heavy ends (C9+) may be collected. In FIG. 1, C1-8 components are fed back through flow switch (4) and into a mass spectrometer (8) and/or gas chromatograph (9) for analysis.

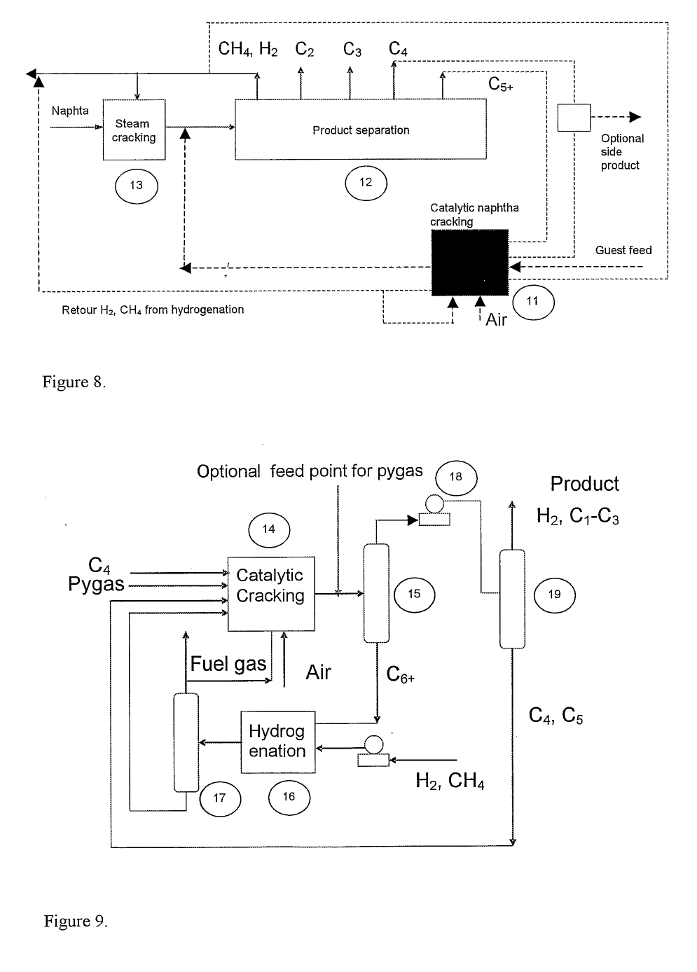

A larger scale apparatus is shown in FIG. 8. The feed is passed into catalytic naphtha cracker (11) and heated by burning fuel gas. The cracked feed is transferred to separator (12) where the components are separated. The separator may also take a feed from a naphtha steam cracker (13). Fractions can then be isolated or recycled by to the cracker (11) for further cracking to occur.

In FIG. 9, a reactor set up for the cracking of pyrolysis gasoline is described. To cracker (14) is fed pyrolysis gasoline and a C4 feed along with hydrogen. The cracked product is transferred to separator (15) where heavy material and tight hydrocarbons are separated. The bottoms stream containing the heavier components is passed through hydrogenator (16) to a further separator (17) where methane and hydrogen are separated and passed back to the cracker or isolated. The bottoms stream is also recycled back to the cracker.

The top stream from separator (15) is itself passed to a further separator (19) via pump (18) where C1-3 fractions are separated from C4/5 fractions. These latter fractions are recycled to the cracker and the light fractions isolated as the desired product.

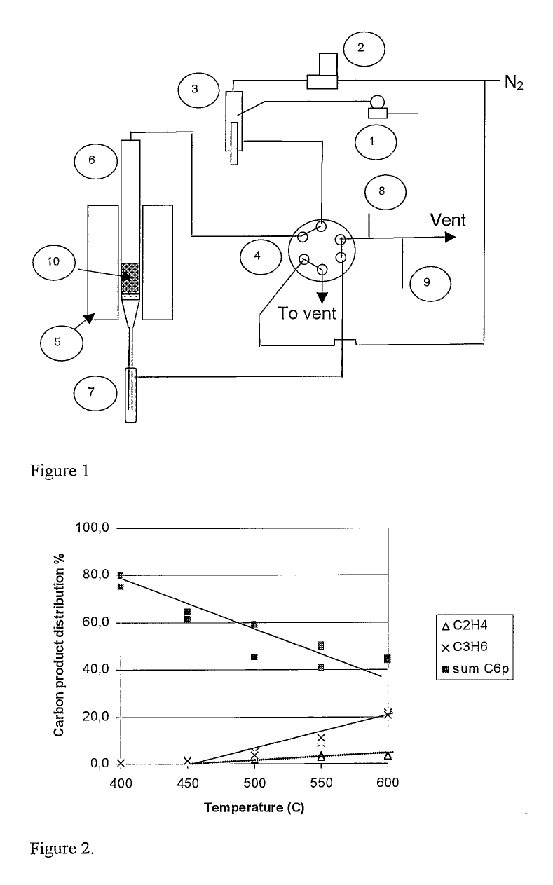

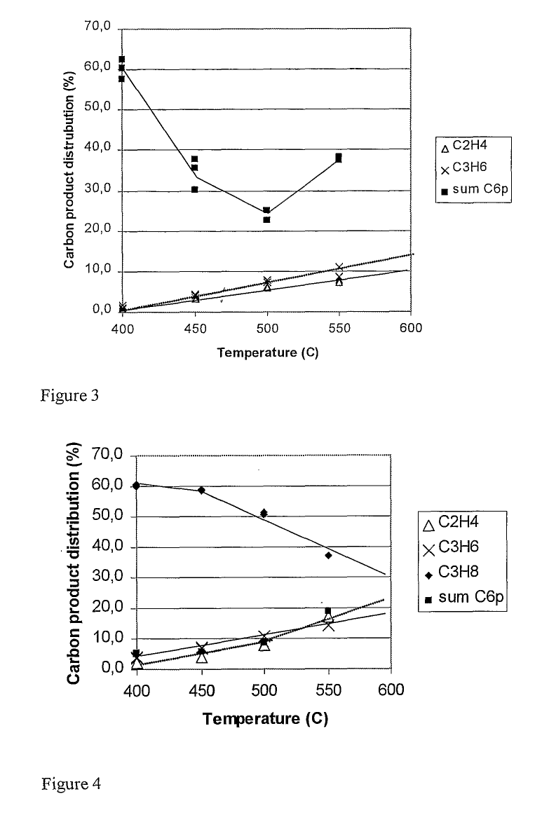

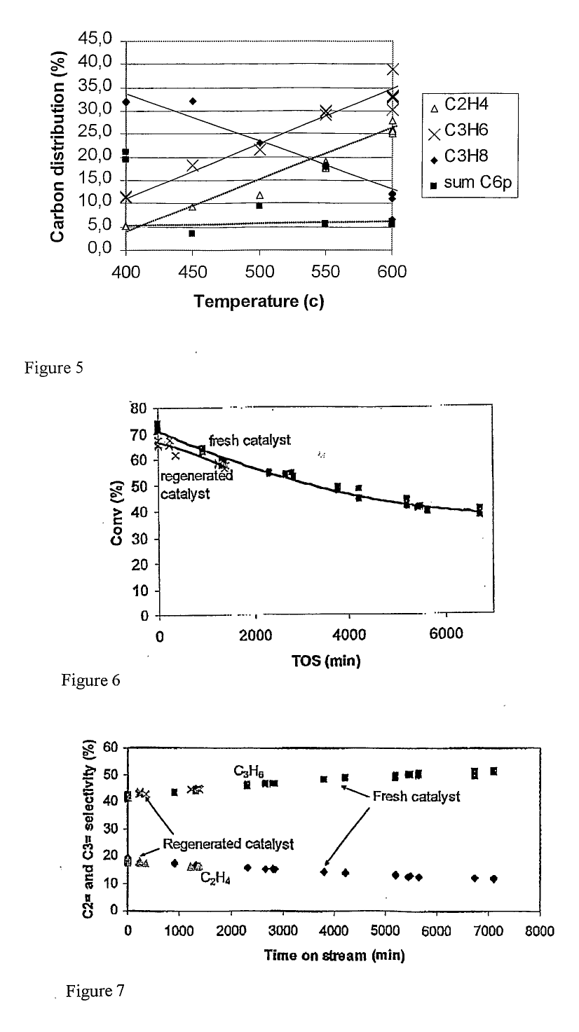

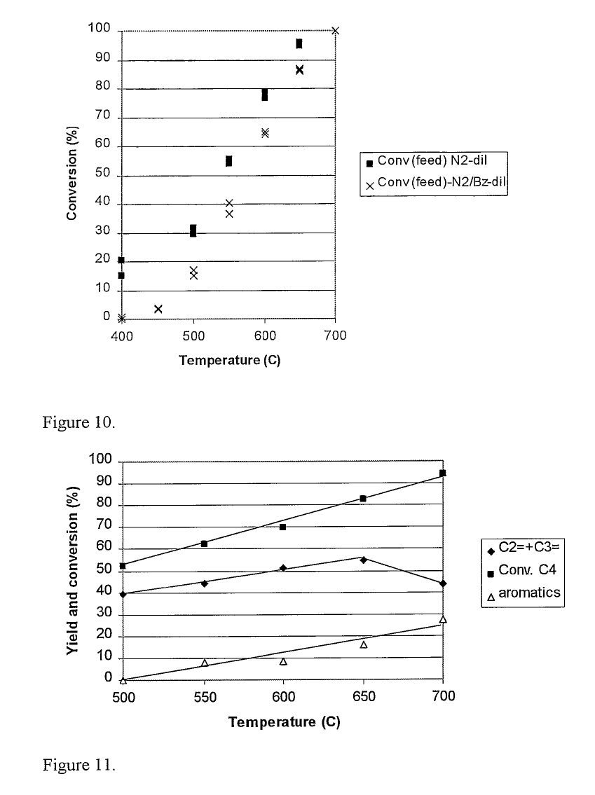

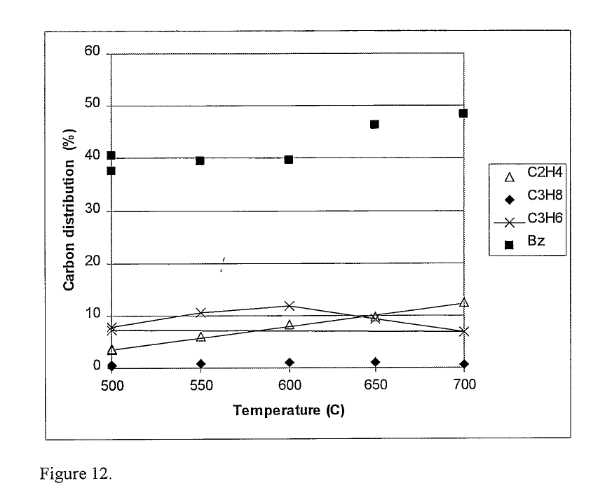

The invention will now be described with reference to the following non-limiting examples and Figures. FIG. 1 shows a potential catalytic cracking reactor set up. FIG. 2 shows the composition in the gas phase in the reactor effluent from catalyst A. FIG. 3 shows the composition in the gas phase in the reactor effluent from catalyst B. FIG. 4 shows the composition in the gas phase in the reactor effluent from catalyst C. FIG. 5 shows the composition in the gas phase in the reactor effluent from catalyst D. FIG. 6 shows conversion of cyclohexane in the presence of HZSM-5 Si/Al=200. FIG. 7 shows selectivity to ethylene and propylene for HZSM-5 Si/Al=200 fresh and regenerated. FIG. 8 shows a potential catalytic cracking reactor set up. FIG. 9 shows a potential catalytic cracking reactor set up. FIG. 10 shows conversion of cyclohexane over HZSM-5 Si/Al=200 at 400-650° C. using either pure nitrogen or nitrogen and benzene as diluent. FIG. 11 shows the conversion of C4 and the yield to C2=/C3=and aromates for catalytic testing of C4 mix over HZSM-5 from Suid Chemie AG (ZPO31400) with a Si/Al=200. FIG. 12 shows carbon distribution in the gas effluent after testing the light fraction of pyrolysis gasoline at increasing temperatures over HZSM-5 from Suid Chemie AG (ZPO31400) with a Si/Al=200.

### EXPERIMENTAL

The reactor set up depicted in FIG. 1 was employed. The condenser was maintained at 75° C. and all transfer lines and switches post evaporator were maintained at a temperature of at least 60° C.

The gas chromatograph used was an Agilente micro GC with four columns. Total analyses of permanent gases and C₁-C₆ took 240 seconds. The gas chromatograph was calibrated with a C₁-C₄ gas mixture (Standard 1) and a mixture of N₂, H₂ and C₁₋₆ (Standard 2). Cyclohexane (CH) was calibrated by pass analysis. All C₅ compounds were assumed to have the same calibration factor and all C₆ compounds were assumed to have the same calibration factor.

### Example 1

Reactions were conducted in the temperature region 400-600° C. with 1 g of catalyst, 50 ml/min N₂ flow through evaporator and 0.1 ml/min hydrocarbon flow corresponding to a WHSV [weight hourly space velocity] of 4.7 gCH/(g catalyst*h) with cyclohexane used as feed. The catalysts were pressed to tablets and then crushed into particles with particle size 0.2 to 0.5 mm before testing.

The reactor was first heated to 400° C. under nitrogen flow before switching to feed from the evaporator. Samples were taken from the reactor at 4-15 minute intervals. N₂ was then flushed through the reactor and the reactor heated to 450° C. before feed from the evaporator was again admitted and the process above repeated. This process was repeated at 500° C., 550° C. and 600° C. before the reactor was cooled to 400° C. or 450° C. for gas chromatographic runs to be performed to check for any catalyst deactivation which may have occurred over the course of the experiment.

Four catalysts were examined using the above protocol:

Catalyst A: Kristal 232 ST (Grace Davison)—a standard cracking catalyst based on rare earth exchanged Y zeolite which has wide pores (12 rings)

Catalyst B: Valfoor CP 811 BL-25 (PQ) a Beta zeolite with wide pores (12 rings)

Catalyst C: A HZSM-5 with Si:Al=28 (Sud Chemie) Medium pores (10 ring)

Catalyst D: A HZSM-5 with Si:Al=85 (ZPO 31170) (Sud Chemie) (10 ring)

Catalysts A to C are comparative, catalyst D exemplifies the invention.

Cracking Catalyst A

The results for this catalyst are shown in FIG. 2 and in Appendix Table 1. The catalyst mostly gave high conversion but deactivated rapidly. Once the temperature returned to 400° C. after testing at 550° C., activity was almost non-existent. The carbon mass balance results indicate that a lot of the carbon forms products that are not analysed in the sampling system, i.e. coke and C6+ hydrocarbons, The high H₂ yield points to coke formation. Within the C3 fraction, the majority was propane as opposed to propene.

Catalyst B

The results for catalyst B are presented in FIG. 3 and Appendix table 2. The catalyst gave rise to products in the C5+ range evidenced by the carbon balance results.

Catalyst C

The results are presented in FIG. 4 and Appendix table 3. Much C3 product is formed by this catalyst but the fraction is primarily propane. The conversion is nevertheless high at all temperatures

Catalyst D

The results for catalyst D are presented in FIG. 5 and Appendix table 4. At 600° C. less than 2% of the cyclohexane is unconverted and there is observed a large selectivity for propene. The combined ethylene and propylene selectivity among the gas phase molecules is over 60% at 600° C. The carbon mass balance at the higher temperature is approximately 80% which means approximately 50% of the formed product is ethylene and propylene. The catalyst showed no deactivation on cooling.

### Examples 2 to 8

General Conditions

| | | | | Amount | | |
|---|---|---|---|---|---|---|
| | | Flow | N₂ flow | of cat. | GHSV | Temp. |
| Exp. | Feed | (ml/min) | (ml/min) | (g)¹ | (h⁻¹)⁷ | (° C.) |
| Ex 2 | CH | 0.1 | 50 | 1 | 4338 | 400-650 |
| Ex 5 | CP | 0.1 | 50 | 1 | 4542 | 400-650 |
| Ex 6 | MeCH | 0.1 | 50 | 1 | 4131 | 400-650 |
| Ex 3 | CH | 0.1 | 50 | 1 | 4338 | 600 |
| Ex 4 | CH | 0.1 | 50 | 1 | 4338 | 600 |
| Ex 7 | HPyglf* | 0.1 | 50 | 1 | 4286 | 400-650 |
| Ex 8 | HPyg** | 0.1 | 50 | 1 | 4110 | 400-650 |

*Hydrogenated pyrolysis gasoline light fraction <125° C.
** Hydrogenated pyrolysis gasoline.

### Example 2

HZSM-5 from Sutd Chemie AG (ZPO31400) with a Si/Al=200 was pressed into tablets and then crushed into particles with particle size 0.2-0.5 mm. One gram of catalyst (1 g) particles was tested at 400-650° C. in a quartz fixed bed reactor with on-line GC analysis. A cyclohexane:N₂ molar ratio of 1:2.2 and a GHSV of 4338 per h was used. Liquid cyclohexane (CH) from Merck (99.6%) was evaporated at 75° C. into the N₂ stream before entering the reactor.

The conversion is calculated on basis of unconverted feed (nitrogen is used as internal standard) and the carbon selectivity* in the effluent to propene and ethylene is shown in Table 1.

TABLE 1
Conversion of CH and C2= and C3= selectivity over HZSM-5

| | | |
|---|---|---|
| Temperature | Conversion | Carbon selectivity* (%) |

| (° C.) | (feed) (%) | C₂H₄ | C₃H₆ |
|---|---|---|---|
| 400 | 17.7 | 3.6 | 24.9 |
| 500 | 30.7 | 9.85 | 33.1 |
| 550 | 54.6 | 15.3 | 37.3 |
| 600 | 77.6 | 20.8 | 40.2 |
| 650 | 95.0 | 29.4 | 37.8 |

*Carbon selectivity calculated based on the analysis of C1-C6 products

### Example 3

The catalyst as described in Example 2 was tested with cyclohexane using the same experimental procedure as described in Example 2. The catalyst was tested for 7105 minutes at 600° C. The conversion as a function of time on stream is shown in FIG. 6. From the results it may easily be derived a half life time of the catalyst of 3.5 days.

The carbon selectivity to ethylene and propene (based on analysis of products C1-C6) is given in FIG. 7.

### Example 4

The catalyst tested in Example 3 was regenerated in 5% oxygen in He. After regeneration the catalyst was tested with CH using the same experimental procedure as described in Example 2. The catalyst was tested for 1397 minutes at 600° C. The conversion as a function of time is shown in FIG. 6 and selectivities to ethylene and propylene in FIG. 7.

### Example 5

The catalyst as described in Example 2 was tested with cyclopentane (CP) using the same experimental procedure as described in Example 2. A CP:N₂ molar ratio of 1:1.9 and a GHSV of 4542 h⁻¹ was used. Liquid CP from Janssen Chimica 16.775.91 (98%) was evaporated at 45° C. into the N₂ stream before entering the reactor.

The conversion calculated on basis of unconverted feed (nitrogen is used as internal standard) and the carbon selectivity* in the effluent to propene and ethylene is shown in Table 2.

TABLE 2
Conversion of CP and C2= and C3= selectivity over HZSM-5

| Temperature | | Carbon selectivity* (%) | |
|---|---|---|---|
| (° C.) | Conversion (feed) (%) | C₂H₄ | C₃H₆ |
| 400 | 7.4 | 2.7 | 20.4 |
| 450 | 20.9 | 7.0 | 23.9 |
| 500 | 40.2 | 12.0 | 29.4 |
| 550 | 68.7 | 17.8 | 33.2 |
| 600 | 90.7 | 26.5 | 38.1 |
| 650 | 99.0 | 35.6 | 37.0 |

*Carbon selectivity calculated based on the analysis of C1-C6 products

### Example 6

### Methylcyclohexane (MCH) as Feed

The catalyst as described in Example 2 was tested with MCP using the same experimental procedure as described in Example 2. A MCP:N₂ molar ratio of 1:2.7 and a GHSV of 4131 h⁻¹ was used. Liquid MCH from Venton 12548 (99%) was evaporated at 90° C. into the N₂ stream before entering the reactor.

The conversion calculated on basis of unconverted feed (nitrogen is used as internal standard) and the carbon selectivity* in the effluent to propene and ethylene is shown in Table 3.

TABLE 3
Conversion of MCH and C2= and C3= selectivity over HZSM-5

| | | |
|---|---|---|
| Temperature | Conversion | Carbon selectivity* (%) |

| (° C.) | (feed) (%) | C₂H₄ | C₃H₆ |
|---|---|---|---|
| 400 | 5.0 | 3.0 | 20.5 |
| 450 | 12.4 | 5.3 | 32.5 |
| 500 | 32.4 | 8.1 | 36.6 |
| 550 | 49.5 | 11.4 | 39.8 |
| 600 | 72.0 | 16.1 | 40.6 |
| 650 | 91.1 | 23.1 | 36.9 |

*Carbon selectivity calculated based on the analysis of C1-C6 products

### Example 7

### Cracking of Hydrogenated Pyrolysis Gasoline (Light Fraction)

Hydrogentated pyrolysis gasoline was obtained from Statoil. Some of the hydrogenated pyrolysis gas was distilled to boiling point 125° C. This corresponds to 69.8 wt % of the feed. 98.7 wt % mass balance was obtained during the distillation (this may indicate that 1.3 wt % of the lightest components have been lost during the distillation). The total hydrogenated pyrolysis gasoline (Example 8) and the light fraction <125° C. (Example 7) were used as feeds.

Piona analyses of the two feeds were performed and the results are given in Tables 5 and 7 below. The total feed contains 80.1 wt % naphthenes and the light feed contains 83.2 wt % naphthenes. The density of the two feeds was measured by weighing 25 ml of the samples. The light fraction <125° C. had a density of 0.744 g/ml and the total hydrogenated pyrolysis gasoline had a density of 0.776 g/ml.

The analysis of the effluent was performed with an Agilente micro GC with 4 columns. All detectors were TC detectors

Column A: 5 A mol sieve

Run at 30.7 psi and 85° C. with Ar as a carrier gas.

Used for analysis of hydrogen and nitrogen

Column B: Poraplot U

Run at 20.7 psi and 70° C. with He carrier gas.

Used for analysis of methane, ethane and ethylene

Column C: Alumina Plot

Run at 34.3 psi and 115° C. with He carrier gas

Used for analysis of propene, propane and C4's

Column D: OV-1

In order to analysis more of the heavy compounds on the GC, the temperature of the D column was increased to 150° C., compared to 70° C. in earlier analysis. Pressure was 29.6 psi. He carrier gas. This column was used to analyse C₅-C₉ compounds.

The catalyst as described in Example 2 was tested with the light fraction boiling <125° C. of a hydrogenated pyrolysis gasoline using the experimental conditions as described in Example 1. A Piona analysis of this feed is given in Table 5 below. The yields to ethene and propene are given Table 6.

TABLE 5

| | C3 | C4 | C5 | C6 | C7 | C8 | C9 | C10 | C11 | C12 |
|---|---|---|---|---|---|---|---|---|---|---|
| Paraffins | 0.020 | 0.120 | 10.202 | 4.420 | 1.021 | 0.165 | 0.016 | 0.000 | 0.000 | 0.000 |
| n-Paraffins | 0.020 | 0.051 | 5.857 | 2.272 | 0.475 | 0.082 | 0.016 | 0.000 | 0.000 | 0.000 |
| iso-Paraffins | | 0.039 | 4.345 | 2.148 | 0.546 | 0.083 | 0.000 | 0.000 | 0.000 | 0.000 |
| Naphthenes | | | 1.967 | 51.053 | 20.296 | 7.988 | 1.317 | 0.617 | 0.000 | 0.000 |
| Mono-naphthenes | | | 1.967 | 51.053 | 20.296 | 7.988 | 0.910 | 0.000 | 0.000 | 0.000 |
| Di-naphthenes | | | | | | 0.000 | 0.408 | 0.617 | 0.000 | 0.000 |
| Aromatics | | | | 0.597 | 0.127 | 0.000 | 0.000 | 0.000 | 0.000 | 0.000 |
| Benzenes | | | | 0.597 | 0.127 | 0.000 | 0.000 | 0.000 | 0.000 | 0.000 |
| Naphthalene | | | | | | | | 0.000 | | |
| Naph-/Olef-benzenes | | | | | | 0.000 | 0.000 | 0.000 | 0.000 | 0.000 |
| Indenes | | | | | | | 0.000 | 0.000 | 0.000 | 0.000 |
| Olefins | | 0.000 | 0.000 | 0.000 | 0.073 | 0.000 | 0.000 | 0.000 | 0.000 | 0.000 |
| n-Olefins | | 0.000 | 0.000 | 0.000 | 0.000 | 0.000 | 0.000 | 0.000 | 0.000 | 0.000 |
| iso-Olefins | | 0.000 | 0.000 | 0.000 | 0.000 | 0.000 | 0.000 | 0.000 | 0.000 | 0.000 |
| Naphtheno-olefins | | | 0.000 | 0.000 | 0.073 | 0.000 | 0.000 | 0.000 | 0.000 | 0.000 |
| Di-olefins | | 0.000 | 0.000 | 0.000 | 0.000 | 0.000 | 0.000 | 0.000 | 0.000 | 0.000 |
| Other olefins | | 0.000 | 0.000 | 0.000 | 0.000 | 0.000 | 0.000 | 0.000 | 0.000 | 0.000 |
| Sum | 0.020 | 0.120 | 12.169 | 56.071 | 21.517 | 8.152 | 1.333 | 0.617 | 0.000 | 0.000 |

TABLE 6
Conversion of pentanes and cyclohexane (CH) and yields
to ethene and propene.

| | Conv. of | | |
|---|---|---|---|
| Temperature | pentane + i- | Conv. of CH | Yields (% ) |

| (° C.) | pentane (%) | (%) | C₂H₄ | C₃H₆ |
|---|---|---|---|---|
| 400 | 3.7 | 1.5 | 0.1 | 1.0 |
| 450 | 8.0 | 9.0 | 0.5 | 3.2 |
| 500 | 17.6 | 30.0 | 1.8 | 7.7 |
| 550 | 16.5 | 49.0 | 5.5 | 16.1 |
| 600 | 20.0 | 72.7 | 10.5 | 23.2 |
| 650 | 54.8 | 93.0 | 16.8 | 25.8 |

The sum of the C2= and C3=yields are about 43% at 650° C. After running the experiment for approximately 8 h, the catalyst has been exposed to feed for approximately 115 min. The conversion at 450° C. was about the same at the end of the experiment as in the start of the experiment, which points to no significant deactivation.

### Example 8

### Hydrogenated Pyrolysis Gasoline (Total Feed)

The catalyst as described in Example 2 was tested with a hydrogenated pyrolysis gasoline using the experimental conditions as described in Example 1. A Piona analysis of this feed is given in Table 7 below. The yield to ethene and propene are given Table 8.

TABLE 7
Piona analysis of the light fraction from hydrogenated pyrolysis gasoline
Values are given in weight %.

| | C3 | C4 | C5 | C6 | C7 | C8 | C9 | C10 | C11 | C12 |
|---|---|---|---|---|---|---|---|---|---|---|
| Paraffins | 0.045 | 0.165 | 13.405 | 4.594 | 0.747 | 0.155 | 0.03 | 0.096 | 0.026 | 0.02 |
| n-Paraffins | 0.045 | 0.111 | 7.616 | 1.754 | 0.345 | 0.084 | 0.03 | 0.019 | 0.026 | 0.02 |
| iso-Paraffins | | 0.053 | 5.789 | 2.84 | 0.402 | 0.071 | 0 | 0.077 | 0 | 0 |
| Naphthenes | | | 2.581 | 36.766 | 14.657 | 4.032 | 8.305 | 11.689 | 2.059 | 0 |
| Mono-naphthenes | | | 2.581 | 36.766 | 14.657 | 3.876 | 6.484 | 0.43 | 0.024 | 0 |
| Di-naphthenes | | | | | | 0.156 | 1.82 | 11.259 | 2.035 | 0 |
| Aromatics | | | | 0.425 | 0.081 | 0.018 | 0 | 0 | 0 | 0 |
| Benzenes | | | | 0.425 | 0.081 | 0.018 | 0 | 0 | 0 | 0 |
| Naphthalene | | | | | | | | 0 | | |
| Naph-/Olef-benzenes | | | | | | 0 | 0 | 0 | 0 | 0 |
| Indenes | | | | | | | 0 | 0 | 0 | 0 |
| Olefins | | 0 | 0 | 0 | 0.051 | 0 | 0 | 0 | 0.053 | 0 |
| n-Olefins | | 0 | 0 | 0 | 0 | 0 | 0 | 0 | 0 | 0 |
| iso-Olefins | 0 | 0 | 0 | 0 | 0 | 0 | 0 | 0 | 0 | 0 |
| Naphtheno-olefins | | | 0 | 0 | 0.051 | 0 | 0 | 0 | 0 | 0 |
| Di-olefins | | 0 | 0 | 0 | 0 | 0 | 0 | 0 | 0 | 0 |
| Other olefins | | 0 | 0 | 0 | 0 | 0 | 0 | 0 | 0.053 | 0 |
| Sum | 0.045 | 0.165 | 15.987 | 41.785 | 15.536 | 4.206 | 8.335 | 11.785 | 2.138 | 0.02 |

TABLE 8
Conversion of pentanes and cyclohexane (CH) and yields
to ethene and propene.

| | | | |
|---|---|---|---|
| | Conv. of | | |
| Temperature | pentane + i- | Conv. of CH | Yields (%) |

| (° C.) | pentane (%) | (%) | C₂H₄ | C₃H₆ |
|---|---|---|---|---|
| 500 | 4.0 | 27.0 | 1.6 | 6.3 |
| 550 | 13.0 | 51.0 | 5.0 | 13.4 |
| 600 | 31.5 | 79.5 | 9.1 | 19.5 |
| 650 | 45.0 | 92.0 | 15.2 | 21.6 |

### Example 9

### Testing with Aromatic Diluent

The catalyst described in Example 2 was tested at 400-650° C. in a quartz fixed bed reactor with online GC analysis. Nitrogen and benzene were used as diluent, along with a cyclohexane:N₂:benzene molar ratio of 1:1.3:1, and at a GHSV 4356 per h. Liquid 1:1 molar mixture of cyclohexane (CH) from Merck (99.6%) and benzene from Merck (p.a.) was evaporated at 80° C. into the nitrogen stream before entering the reactor.

In FIG. 10 the conversion of CH is compared with the results from Example 2. In Table 9 the selectivity based on the products are given. In the selectivity calculations, it is assumed that benzene is not a product, which influences the results at temperatures higher than 600° C.

TABLE 9
Conversion and selectivity over HZSM-5 Si/Al = 200

| | | | | Selectivity (%) | | | | | |
|---|---|---|---|---|---|---|---|---|---|
| | Conversion (%) | | | 400° C. | | 500° C. | | 600° C. | |
| Experiment | 400° C. | 500° C. | 600 | C₂= | C₃= | C₂= | C₃= | C₂= | C₃= |
| Ex 2 | 17.7 | 30.7 | 77.6 | 3.6 | 24.9 | 9.9 | 33.1 | 20.8 | 40.2 |
| Ex 9 | 19.4 | 16.0 | 64.6 | 1.8 | 19.4 | 6.1 | 32.1 | 12.9 | 32.5 |

*0.1 ml/min CH (liq) + 50 ml/min N2,
**0.1 ml/min CH (liq) + 0.098 ml/min Bz (liq) + 27.7 ml/min N2.

### Example 10

### Testing of a C4 Mix

HZSM-5 from Sud Chemie AG (ZPO31400) with a Si/Al=200 was pressed into tablets and then crushed into particles with particle size 0.2-0.5 mm. One gram of catalyst (1 g) particles was tested at 500-700° C. in a quartz fixed bed reactor with on-line GC analysis.

C4 mix obtained from a commercial steam cracker 19 ml/min and 25 ml/min nitrogen was used as feed. The C4 mix was contained as a liquid in a container keeping a pressure of 1.5 bar. This was taken from a stream where the original C4 mix had been exposed to a partial hydrogenation of butadiene, and thereafter the isobutene removed by reacting to methyltertbutylether. The analysis of the C4 mix was performed on a separate GC and the analysis is given in Table 10.

TABLE 10
Analysis of C4 mix obtained from commercial steam cracker

| Component | Mol % |
|---|---|
| Isobutane | 3.3 |
| n-butane | 25.9 |
| 1-butene | 20.2 |
| Trans-butene | 35.8 |
| cis-2-butene | 15.3 |

The conversion of the C4's and the yield to C2=/C3= and aromates are given in FIG. 11. This example shows that the process is well suited for cracking of C4 mix into light olefins and up to 50% yield to C2=/C3= is achieved at 600-650° C.

### Example 11

### Using Light Fraction of Pyrolysis Gasoline as Feed

The catalyst (1 g) as described in Example 2 was tested with the light fraction of pyrolysis gasoline as feed. The pyrolysis gasoline was distilled and the fraction boiling at ≦125° C. was used as feed. This corresponds to 82% of the pyrolysis gasoline sample. Analysis of the light fraction of the pyrolysis gasoline was performed on a separate GC and the analysis is given in Table 11. This light fraction had a density of 0.798 g/ml.

The liquid feed was fed with 0.1 ml/min and evaporated into a 50 ml/min nitrogen stream before entering the reactor.

TABLE 11
Analysis of “light fraction” of pyrolysis
gasoline (not hydrogenated)

| Component | Wt % |
|---|---|
| Benzene | 35.5 |
| Toluene | 10.9 |
| Other C₅-C₈, mainly C₅ | 49.0 |
| Xylenes + ethylbenzene | 4.6 |

The carbon distribution in the gas effluent is given in FIG. 12. This example shows that the process cracks 20% of the light naphta into C2=/C3=. This corresponds to 16.4% of the total pyrolysis gasoline.

TABLE 1
The cracking catalyst A

| | | | Mol % i gas phase | | | | | | | | | | |
|---|---|---|---|---|---|---|---|---|---|---|---|---|---|
| | sum | | | | | | | | | | | | |
| | mol % in | C | | | | | | | sum | sum | sum | | sum |
| Temp | loop | balance | H₂ | CH₄ | C₂H₄ | C₂H₆ | C₃H₆ | C₃H₈ | C₄ | C₅ | C₆prod | unconv | C*n |
| 400 | 102.9 | 80.6 | 0.1 | 0.0 | 0.1 | 0.0 | 0.0 | 0.5 | 0.7 | 0.2 | 3.8 | 22.0 | 28.5 |
| 400 | 103.2 | 83.8 | 0.1 | 0.0 | 0.1 | 0.0 | 0.0 | 0.4 | 0.5 | 0.7 | 3.5 | 23.0 | 27.8 |
| 450 | 101.5 | 77.4 | 0.4 | 0.0 | 0.4 | 0.0 | 0.3 | 2.0 | 1.8 | 1.1 | 5.4 | 16.3 | 52.9 |
| 450 | 103.5 | 105.5 | 0.5 | 0.2 | 0.4 | 0.1 | 0.3 | 2.1 | 2.0 | 1.3 | 7.0 | 21.0 | 65.1 |
| 500 | 101.3 | 75.8 | 2.6 | 0.8 | 1.0 | 0.3 | 1.3 | 4.9 | 3.2 | 1.3 | 5.7 | 10.7 | 75.2 |
| 500 | 104.2 | 130.9 | 2.6 | 0.7 | 0.8 | 0.2 | 1.2 | 4.3 | 3.2 | 1.0 | 9.0 | 20.0 | 91.1 |
| 550 | 101.6 | 74.4 | 8.9 | 2.3 | 1.3 | 0.7 | 2.4 | 4.9 | 2.5 | 1.0 | 5.0 | 8.7 | 73.0 |
| 550 | 123.5 | 88.3 | 8.6 | 1.8 | 1.1 | 0.5 | 2.3 | 4.0 | 2.3 | 1.1 | 6.3 | 17.6 | 76.2 |
| 550 | 103.3 | 100.1 | 6.8 | 1.4 | 0.8 | 0.4 | 1.9 | 2.8 | 1.6 | 0.9 | 4.8 | 18.3 | 58.0 |
| 550 | 209.7 | 82.5 | 6.4 | 1.3 | 0.7 | 0.3 | 1.9 | 2.3 | 1.4 | 0.8 | 4.1 | 18.0 | 49.9 |
| 600 | 103.8 | 89.2 | 7.6 | 1.2 | 0.7 | 0.2 | 2.6 | 1.0 | 0.9 | 0.6 | 2.6 | 20.1 | 35.7 |
| 600 | 113.9 | 82.4 | 6.5 | 0.9 | 0.5 | 0.2 | 2.1 | 0.7 | 0.8 | 0.6 | 2.3 | 22.6 | 30.8 |

| Product carbon % in gas phase | | | | | | | | |
|---|---|---|---|---|---|---|---|---|
| | | | | | | sum | sum | sum |
| Temp | Metan | C₂H₄ | C₂H₆ | C₃H₆ | C₃H₈ | C₄ | C₅ | C₆p |
| 400 | 0.0 | 0.7 | 0.1 | 0.5 | 5.3 | 10.0 | 3.7 | 79.8 |
| 400 | 0.0 | 0.6 | 0.1 | 0.5 | 4.1 | 7.6 | 11.9 | 75.3 |
| 450 | 0.0 | 1.4 | 0.2 | 1.7 | 11.4 | 14.0 | 10.0 | 61.5 |
| 450 | 0.3 | 1.2 | 0.2 | 1.5 | 9.7 | 12.5 | 10.1 | 64.5 |
| 500 | 1.1 | 2.6 | 0.7 | 5.1 | 19.5 | 17.1 | 8.6 | 45.2 |
| 500 | 0.8 | 1.9 | 0.5 | 3.8 | 14.1 | 14.2 | 5.6 | 59.0 |
| 550 | 3.2 | 3.6 | 1.9 | 10.0 | 20.2 | 13.7 | 6.6 | 40.7 |
| 550 | 2.4 | 2.9 | 1.4 | 8.9 | 15.8 | 12.2 | 7.1 | 49.4 |
| 550 | 2.5 | 2.9 | 1.2 | 9.9 | 14.5 | 11.3 | 7.5 | 50.1 |
| 550 | 2.6 | 3.0 | 1.2 | 11.3 | 14.0 | 11.2 | 7.5 | 49.2 |
| 600 | 3.4 | 3.6 | 1.3 | 21.5 | 8.2 | 9.9 | 8.5 | 43.6 |
| 600 | 2.9 | 3.4 | 1.1 | 20.8 | 7.1 | 11.0 | 9.0 | 44.7 |

TABLE 2
Catalyst B Zeolite Beta

| | | | Mol % in gas phase | | | | | | | | | | |
|---|---|---|---|---|---|---|---|---|---|---|---|---|---|
| | sum | C | | | | | | | | | | | |
| Temp | mol % in | balance | | | | | | | sum | sum | sum | | sum |
| (° C.) | loop | (%) | H₂ | CH₄ | C₂H₄ | C₂H₆ | C₃H₆ | C₃H₈ | C₄ | C₅ | C₆prod | unconv | C*n |
| 400 | 98.7 | 71.7 | 5.3 | 0.8 | 0.5 | 0.1 | 0.3 | 4.4 | 7.0 | 4.1 | 6.9 | 3.1 | 106.3 |
| 400 | 102.0 | 79.7 | 5.3 | 0.6 | 0.4 | 0.0 | 0.3 | 2.4 | 4.2 | 2.8 | 9.2 | 8.1 | 95.8 |
| 400 | 99.8 | 55.7 | 3.3 | 0.4 | 0.3 | 0.0 | 0.2 | 1.5 | 2.2 | 1.8 | 5.9 | 8.7 | 58.9 |
| 400 | 98.6 | 45.1 | 2.6 | 0.3 | 0.2 | 0.0 | 0.2 | 1.0 | 1.7 | 1.2 | 4.8 | 8.0 | 45.8 |
| 450 | 97.9 | 42.6 | 9.6 | 1.0 | 0.9 | 0.1 | 0.6 | 3.4 | 3.6 | 1.8 | 2.8 | 4.0 | 55.0 |
| 450 | 96.0 | 34.6 | 7.5 | 0.8 | 0.6 | 0.1 | 0.5 | 2.0 | 2.2 | 1.1 | 2.2 | 5.1 | 36.9 |
| 450 | 96.1 | 30.3 | 6.4 | 0.7 | 0.5 | 0.1 | 0.4 | 1.5 | 1.7 | 0.9 | 1.9 | 5.2 | 30.2 |
| 500 | 94.1 | 30.0 | 14.2 | 1.7 | 1.2 | 0.3 | 1.0 | 3.1 | 2.6 | 0.8 | 1.5 | 2.0 | 40.5 |
| 500 | 94.6 | 30.1 | 13.0 | 1.6 | 1.1 | 0.2 | 1.0 | 2.6 | 2.3 | 0.8 | 1.6 | 2.7 | 37.8 |
| 550 | 93.2 | 27.5 | 21.2 | 2.8 | 1.6 | 0.5 | 1.2 | 2.6 | 1.4 | 0.2 | 2.6 | 0.4 | 40.1 |
| 550 | 93.8 | 29.9 | 18.9 | 2.5 | 1.5 | 0.4 | 1.5 | 2.2 | 1.6 | 0.3 | 2.5 | 1.3 | 40.6 |
| 450 | 97.6 | 45.2 | 5.1 | 0.5 | 0.3 | 0.0 | 0.3 | 0.4 | 0.6 | 0.4 | 1.5 | 12.3 | 17.1 |

| | Product carbon % in gas phase | | | | | | | |
|---|---|---|---|---|---|---|---|---|
| Temp | | | | | | sum | sum | sum |
| (° C.) | Metan | C₂H₄ | C₂H₆ | C₃H₆ | C₃H₈ | C₄ | C₅ | C₆p |

| | | | | | | | | |
|---|---|---|---|---|---|---|---|---|
| 400 | 0.8 | 0.9 | 0.1 | 0.8 | 12.6 | 26.5 | 19.5 | 38.8 |
| 400 | 0.6 | 0.8 | 0.1 | 1.1 | 7.5 | 17.6 | 14.6 | 57.7 |
| 400 | 0.7 | 0.9 | 0.1 | 0.9 | 7.4 | 14.7 | 15.0 | 60.3 |
| 400 | 0.7 | 1.0 | 0.1 | 1.6 | 6.8 | 14.6 | 12.7 | 62.5 |
| 450 | 1.9 | 3.1 | 0.4 | 3.5 | 18.4 | 26.1 | 16.3 | 30.3 |
| 450 | 2.2 | 3.2 | 0.4 | 3.9 | 16.0 | 23.6 | 15.0 | 35.6 |
| 450 | 2.3 | 3.3 | 0.4 | 4.3 | 15.1 | 22.8 | 14.2 | 37.6 |
| 500 | 4.3 | 6.1 | 1.3 | 7.3 | 22.8 | 25.9 | 9.8 | 22.5 |
| 500 | 4.1 | 6.0 | 1.3 | 7.9 | 20.7 | 24.8 | 10.1 | 25.0 |
| 550 | 7.1 | 7.7 | 2.4 | 8.7 | 19.4 | 14.1 | 2.4 | 38.2 |
| 550 | 6.0 | 7.3 | 2.0 | 10.9 | 16.1 | 16.0 | 4.1 | 37.4 |
| 450 | 2.9 | 3.1 | 0.3 | 5.6 | 7.3 | 15.1 | 11.4 | 54.4 |

TABLE 3
Catalyst C, HZSM-5 with Si/Al = 28

| | | | Mol % in gas phase | | | | | | | | | | |
|---|---|---|---|---|---|---|---|---|---|---|---|---|---|
| | sum | C | | | | | | | | | | | |
| Temp | mol % in | balance | | | | | | | sum | sum | sum | | sum |
| (° C.) | loop | (%) | H₂ | CH₄ | C₂H₄ | C₂H₆ | C₃H₆ | C₃H₈ | C₄ | C₅ | C₆prod | unconv | C*n |
| 400 | 101.5 | 48.0 | 1.2 | 0.2 | 0.7 | 0.3 | 0.9 | 15.4 | 4.3 | 0.8 | 0.6 | 2.9 | 76.4 |
| 400 | 101.0 | 51.4 | 1.2 | 0.2 | 0.8 | 0.3 | 1.0 | 16.6 | 4.6 | 0.9 | 0.7 | 2.6 | 82.1 |
| 400 | 100.6 | 47.8 | 1.1 | 0.2 | 0.8 | 0.3 | 0.9 | 15.7 | 4.2 | 0.9 | 0.7 | 2.5 | 77.5 |
| 400 | 100.1 | 46.9 | 1.1 | 0.2 | 0.7 | 0.3 | 0.9 | 15.2 | 4.3 | 0.8 | 0.7 | 2.5 | 75.9 |
| 400 | 100.3 | 48.4 | 1.1 | 0.2 | 0.7 | 0.3 | 0.9 | 15.7 | 4.4 | 0.8 | 0.7 | 2.5 | 77.9 |
| 400 | 99.9 | 49.7 | 1.1 | 0.2 | 0.8 | 0.3 | 1.0 | 15.8 | 4.4 | 0.9 | 0.7 | 2.7 | 78.6 |
| 400 | 100.3 | 48.5 | 1.2 | 0.2 | 0.8 | 0.3 | 0.9 | 15.7 | 4.4 | 0.9 | 0.6 | 2.5 | 78.0 |
| 400 | 101.8 | 50.8 | 1.3 | 0.2 | 0.8 | 0.3 | 1.0 | 16.1 | 4.5 | 0.9 | 0.6 | 3.0 | 79.8 |
| 400 | 100.2 | 43.6 | 1.2 | 0.2 | 0.7 | 0.3 | 0.9 | 14.2 | 3.9 | 0.8 | 0.6 | 2.5 | 70.8 |
| 400 | 100.9 | 44.4 | 1.2 | 0.2 | 0.7 | 0.3 | 0.9 | 14.2 | 3.9 | 0.8 | 0.6 | 2.9 | 70.9 |
| 450 | 99.5 | 40.4 | 3.0 | 0.6 | 1.5 | 0.6 | 1.8 | 14.6 | 3.6 | 0.5 | 0.7 | 0.4 | 74.8 |
| 450 | 100.0 | 40.1 | 2.9 | 0.6 | 1.5 | 0.6 | 1.7 | 14.7 | 3.6 | 0.5 | 0.7 | 0.3 | 75.2 |
| 450 | 100.4 | 44.3 | 3.2 | 0.6 | 1.5 | 0.7 | 1.8 | 15.9 | 3.9 | 0.6 | 0.8 | 0.3 | 81.2 |
| 500 | 99.6 | 40.6 | 6.3 | 1.9 | 2.8 | 1.2 | 2.6 | 12.5 | 2.6 | 0.2 | 1.0 | 0.1 | 72.9 |
| 500 | 98.9 | 37.2 | 6.2 | 1.7 | 2.7 | 1.1 | 2.4 | 11.5 | 2.4 | 0.2 | 1.0 | 0.0 | 68.2 |
| 550 | 94.7 | 27.5 | 10.3 | 0.0 | 4.2 | 1.6 | 2.3 | 6.1 | 0.7 | 0.0 | 1.5 | 0.1 | 49.0 |

| | Product carbon % in gas phase | | | | | | | |
|---|---|---|---|---|---|---|---|---|
| Temp | | | | | | sum | sum | sum |
| (° C.) | Metan | C₂H₄ | C₂H₆ | C₃H₆ | C₃H₈ | C₄ | C₅ | C₆p |
| 400 | 0.3 | 2.0 | 0.8 | 3.7 | 60.4 | 22.6 | 5.4 | 4.9 |
| 400 | 0.2 | 1.9 | 0.8 | 3.5 | 60.7 | 22.6 | 5.4 | 4.8 |
| 400 | 0.2 | 2.0 | 0.8 | 3.7 | 60.7 | 21.8 | 5.7 | 5.1 |
| 400 | 0.2 | 1.9 | 0.8 | 3.7 | 60.3 | 22.4 | 5.3 | 5.3 |
| 400 | 0.2 | 1.9 | 0.8 | 3.6 | 60.3 | 22.6 | 5.4 | 5.1 |
| 400 | 0.2 | 1.9 | 0.8 | 3.7 | 60.2 | 22.4 | 5.5 | 5.2 |
| 400 | 0.2 | 1.9 | 0.8 | 3.6 | 60.5 | 22.3 | 5.6 | 5.0 |
| 400 | 0.3 | 2.0 | 0.8 | 3.6 | 60.4 | 22.6 | 5.5 | 4.9 |
| 400 | 0.3 | 2.1 | 0.8 | 3.9 | 60.2 | 22.3 | 5.4 | 5.0 |
| 400 | 0.3 | 2.1 | 0.8 | 3.9 | 60.0 | 22.1 | 5.8 | 5.0 |
| 450 | 0.8 | 4.0 | 1.6 | 7.1 | 58.5 | 19.0 | 3.3 | 5.8 |
| 450 | 0.7 | 3.9 | 1.6 | 7.0 | 58.5 | 19.1 | 3.4 | 5.7 |
| 450 | 0.7 | 3.8 | 1.6 | 6.8 | 58.8 | 19.0 | 3.6 | 5.6 |
| 500 | 2.6 | 7.8 | 3.4 | 10.5 | 51.3 | 14.2 | 1.5 | 8.6 |
| 500 | 2.5 | 8.0 | 3.4 | 10.8 | 50.7 | 14.2 | 1.5 | 9.0 |
| 550 | 0.0 | 17.1 | 6.3 | 14.3 | 37.1 | 5.9 | 0.4 | 18.9 |

TABLE 4
Catalyst D, HZSM-5 with Si/Al = 85

| | | | Mol % in gas phase | | | | | | | | | | |
|---|---|---|---|---|---|---|---|---|---|---|---|---|---|
| | sum | C | | | | | | | | | | | |
| Temp | mol % in | balance | | | | | | | sum | sum | sum | | sum |
| (° C.) | loop | (%) | H₂ | CH₄ | C₂H₄ | C₂H₆ | C₃H₆ | C₃H₈ | C₄ | C₅ | C₆prod | unconv | C*n |
| 600 | 103.5 | 86.0 | 9.2 | 2.2 | 16.1 | 2.0 | 11.5 | 4.2 | 4.3 | 1.1 | 1.0 | 0.3 | 114.8 |
| 600 | 97.7 | 81.9 | 8.9 | 1.9 | 13.8 | 1.0 | 11.6 | 4.2 | 4.3 | 0.7 | 1.0 | 0.3 | 106.1 |
| 600 | 96.7 | 82.2 | 8.8 | 1.8 | 13.5 | 1.0 | 11.6 | 4.3 | 4.3 | 0.7 | 1.0 | 0.3 | 105.3 |
| 600 | 96.0 | 79.3 | 8.7 | 1.7 | 13.1 | 0.9 | 11.4 | 4.1 | 4.2 | 0.7 | 1.0 | 0.3 | 102.8 |
| 600 | 96.2 | 81.9 | 8.7 | 2.7 | 13.2 | 1.0 | 13.6 | 2.3 | 4.3 | 0.7 | 1.0 | 0.3 | 104.9 |
| 600 | 96.4 | 79.4 | 8.6 | 1.7 | 13.1 | 1.0 | 11.4 | 4.1 | 4.2 | 0.7 | 1.0 | 0.3 | 103.3 |
| 550 | 97.0 | 80.9 | 6.7 | 0.8 | 8.8 | 0.6 | 9.9 | 6.0 | 5.3 | 1.1 | 0.9 | 2.7 | 99.3 |
| 550 | 96.9 | 78.9 | 6.5 | 0.8 | 8.8 | 0.6 | 9.8 | 5.9 | 5.2 | 1.1 | 0.9 | 2.7 | 98.0 |
| 550 | 96.5 | 80.7 | 6.5 | 0.8 | 8.8 | 0.6 | 9.9 | 6.0 | 5.2 | 1.1 | 0.9 | 2.7 | 99.0 |
| 550 | 96.9 | 81.9 | 6.5 | 0.8 | 8.8 | 0.6 | 10.0 | 6.1 | 5.3 | 1.1 | 0.9 | 2.7 | 100.3 |
| 550 | 102.1 | 81.2 | 6.8 | 1.1 | 9.9 | 0.7 | 10.0 | 6.2 | 5.4 | 1.1 | 0.9 | 3.0 | 104.0 |
| 550 | 98.0 | 80.7 | 6.5 | 0.9 | 9.0 | 0.7 | 9.9 | 6.0 | 5.3 | 1.1 | 0.9 | 2.8 | 100.0 |
| 500 | 105.5 | 101.8 | 3.6 | 0.7 | 5.4 | 0.4 | 6.7 | 7.1 | 5.9 | 3.0 | 1.6 | 10.3 | 102.1 |
| 450 | 101.6 | 90.5 | 1.3 | 0.5 | 2.0 | 0.1 | 2.6 | 4.6 | 2.8 | 0.7 | 0.2 | 19.6 | 42.7 |
| 400 | 100.4 | 96.2 | 0.3 | 0.4 | 0.5 | 0.0 | 0.7 | 1.9 | 1.0 | 0.3 | 0.6 | 26.2 | 17.6 |
| 400 | 100.7 | 103.4 | 0.3 | 0.2 | 0.5 | 0.0 | 0.7 | 2.0 | 1.0 | 0.3 | 0.6 | 27.6 | 18.5 |

| | Product carbon % in gas phase | | | | | | | |
|---|---|---|---|---|---|---|---|---|
| Temp | | | | | | sum | sum | sum |
| (° C.) | Metan | C₂H₄ | C₂H₆ | C₃H₆ | C₃H₈ | C₄ | C₅ | C₆p |
| 600 | 1.9 | 28.0 | 3.5 | 30.2 | 11.1 | 15.0 | 4.8 | 5.4 |
| 600 | 1.8 | 26.0 | 1.8 | 32.8 | 11.9 | 16.3 | 3.4 | 5.9 |
| 600 | 1.7 | 25.6 | 1.8 | 33.0 | 12.1 | 16.5 | 3.3 | 5.9 |
| 600 | 1.7 | 25.5 | 1.8 | 33.2 | 12.0 | 16.4 | 3.4 | 6.0 |
| 600 | 1.6 | 25.1 | 1.8 | 38.8 | 6.7 | 16.6 | 3.5 | 5.9 |
| 600 | 1.7 | 25.4 | 1.8 | 33.2 | 12.0 | 16.4 | 3.4 | 6.0 |
| 550 | 0.8 | 17.7 | 1.2 | 29.9 | 18.1 | 21.1 | 5.6 | 5.5 |
| 550 | 0.8 | 17.9 | 1.2 | 29.9 | 18.0 | 21.0 | 5.6 | 5.6 |
| 550 | 0.8 | 17.8 | 1.2 | 29.9 | 18.1 | 21.1 | 5.6 | 5.4 |
| 550 | 0.8 | 17.5 | 1.2 | 30.0 | 18.2 | 21.2 | 5.6 | 5.5 |
| 550 | 1.1 | 19.1 | 1.4 | 28.9 | 17.9 | 20.7 | 5.5 | 5.3 |
| 550 | 0.9 | 18.0 | 1.3 | 29.7 | 18.0 | 21.1 | 5.6 | 5.4 |
| 500 | 0.8 | 11.7 | 0.9 | 21.6 | 22.9 | 25.1 | 4.9 | 9.5 |
| 450 | 1.2 | 9.3 | 0.6 | 18.2 | 32.2 | 26.7 | 8.3 | 3.4 |
| 400 | 2.0 | 5.3 | 0.3 | 11.6 | 32.1 | 21.6 | 7.7 | 19.4 |
| 400 | 1.3 | 5.2 | 0.3 | 11.1 | 31.9 | 21.5 | 7.7 | 21.0 |

1-21. (canceled)

22. A process for cracking C₄+ hydrocarbon feedstock comprising saturated cyclic hydrocarbons, said process comprising:
heating the feedstock at a temperature of 400-800° C. in the presence of an H-ZSM-5 catalyst having a silicon to aluminum ration of 61-1,000.

23. The process of claim 1, wherein the C4+ hydrocarbon feedstock comprises at least one C4+ olefin.

24. The process of claim 1, wherein the C₄+ hydrocarbon feedstock is hydrogenated prior to cracking.

25. The process of claim 1 for cracking C₅+ hydrocarbon feedstock.

26. The process of claim 1, wherein the hydrocarbon feedstock comprises saturated paraffins, olefins of general formula CₙH₂ₙ where n is from 4 to 12 or mixtures thereof.

27. The process of claim 26, wherein the hydrocarbon feedstock comprises cyclohexane.

28. The process of claim 1, wherein the C₄+ hydrocarbon feedstock is derived from pyrolysis gasoline or hydrogenated pyrolysis gasoline.

29. The process of claim 1, wherein the hydrocarbon feedstock comprises aromatic compounds.

30. The process of claim 1, wherein the process takes place in a cracker.

31. The process of claim 30, wherein at least a portion of the cracked hydrocarbon feedstock is recycled back to the cracker and undergoes further cracking.

32. The process claim 31, wherein the cracked hydrocarbon feedstock is recycled through a hydrogenator before being returned to the cracker.

33. The process of claim 1, wherein the temperature is 570-650° C.

34. The process of claim 1, wherein the ratio of Si:Al is 80 to 400.

35. The process of claim 1, wherein the ratio of Si:Al is 85-200.

36. The process of claim 1, wherein the amount of ethylene and propylene formed is at least 40 wt % carbon.

37. The process of claim 1, wherein the ratio of formed propylene to ethylene is greater than 1.2:1.

38. The process of claim 1, wherein the amount of propylene formed is at least 30 wt % carbon.

39. The process of claim 1, wherein at least 60% of the C₄+ hydrocarbon feedstock is cracked.

40. The process of claim 1, wherein the HZSM-5 catalyst is not hydrothermally treated.

41. The process of claim 1, wherein the HZSM-5 catalyst contains less than 0.05% wt cations besides than protons.

42. The use of an HZSM-5 catalyst having silicon to aluminum ratio of 61-1000 as a catalyst in the cracking of C₄+ hydrocarbon feedstock comprising saturated cyclic hydrocarbons.
